(19) United States
(12) Patent Application Publication
(10) Pub. No.: US 2018/0204149 A1
(43) Pub. Date: Jul. 19, 2018

(54) DOMAIN-SPECIFIC BUSINESS OBJECTS FOR PROCESS DESIGN

(71) Applicant: Xerox Corporation, Norwalk, CT (US)

(72) Inventors: Mario Cortes Cornax, Grenoble (FR); Adrian Corneliu Mos, Meylan (FR)

(73) Assignee: Xerox Corporation, Norwalk, CT (US)

(21) Appl. No.: 15/407,546

(22) Filed: Jan. 17, 2017

(51) Int. Cl. G06Q 10/06

(52) U.S. Cl. CPC G06Q 10/067; G06F 3/0484

(57) ABSTRACT

A system and method provide for incorporating domain-specific business objects into process design. The method includes providing a domain meta-model, which links a set of elements, the elements including domain-specific business objects representing pieces of data, each of the domain-specific business objects being associated with a set of features, the set of features including an identifier feature. Business object definitions for types of domain-specific business objects are incorporated into the domain meta-model to generate a domain model including the defined domain-specific business objects. A domain-specific process studio is generated, based on the domain model, which enables a user to edit a representation of a business process that includes a sequence of process steps. The representation of the business process includes at least one process step that is linked to one of the domain-specific business objects in the domain model. One or more of the steps of the method may be performed with a processor.

### BACKGROUND

The exemplary embodiment relates to business process design and finds particular application in connection with a system and method for generating complex integrated development environments for domain-specific business processes that incorporate domain-specific business objects.

Business Process Management (BPM) and Service Oriented Architectures (SOA) are two significant aspects of business enterprise solutions. BPM addresses the methodology and tools that enable the management of business processes (BPs) as they evolve throughout their lifecycles. A Business Process Management Suite (BPMS) executes business processes and connects them to various enterprise resources, such as a personnel directory, various legacy applications, and, in some cases, to the organization's SOA. An enterprise SOA typically manages the reusable technical services used to execute tasks that occur in business processes. Their functionality, granularity, and interfaces define their level of reuse across a multitude of business processes. In general, the closer the SOA services match the business requirements, the faster it is to implement new business processes.

Business process design is used in Business Process Management (BPM) and enables the expression of the inner workings of business processes to render them executable. This complements and improves the classical business application development practices where requirements are typically passed on to developers that create the application. Business processes (BPs) are often modeled in abstract terms by business-oriented users who have a good business knowledge and understanding of the various roles in the organization, but who are not necessarily familiar with the details of the Information Technology (IT) services that will ultimately be used to implement the processes in the SOA. Using BPM, business analysts can design, manage and control business processes themselves, up to the execution and analysis of the results. Business-oriented users typically use a language such as Business Process Model and Notation (BPMN) to describe a business process. BPMN is a generic language, which has flowchart-like metaphors and a number of other elements that are useful for business process design. This language contains elements such as “activity,” “gateway,” “signal,” and “flow”. Users often describe their BPs by assigning textual labels such as “payment” or “customer registration” to the generic BPMN elements. Once the business process descriptions are created, a BPMN editor enables users to assign roles from the organization's hierarchy to human activities, to generate forms for manual tasks, to write business rules in scripting languages to condition various execution flows as well as to connect certain tasks to SOA services, among other features. The business analysts may create the process designs graphically using BPMN with the goal of eventually executing the processes on an appropriate infrastructure supported by the BPMS.

Most of BPM existing solutions are domain-independent and platform-dependent, so that they can be used for any business process in any domain (e.g., healthcare, transportation, finance, etc.). As a result, they tend to be too generic and technical for use by business experts, limiting the involvement of business matter experts, in particular for design activities. Business analysts look for dedicated means (i.e., a specific type of task with implicit domain knowledge) to model their business domain, such as logistics, healthcare, transportation, etc., more effectively [J. Pinggera, et al., “How the structuring of domain knowledge helps casual process modelers,” Conceptual Modeling—ER 2010, Springer, pp. 445-451, 2010]. To deal with this, Domain Specific Languages (DSLs) are an effective means to cope with application domains providing improvements in expressiveness and ease of use [M. Mernik, et al., “When and how to develop domain-specific languages,” ACM computing surveys (CSUR), vol. 37, no. 4, pp. 316-344, 2005]. More specifically, Domain Specific Process Modeling Languages (DSPMLs) can be used by business stakeholders to design their processes in a much more intuitive way than actual standards, such as BPMN [S. Jablonski, et al., “Evolution of business process models and languages,” 2nd Int'l Conf. on Business Process and Services Computing (BPSC), pp. 46-59, 2009; N Lagos, et al., “Preserving Consistency in Domain-Specific Business Processes Through Semantic Representation of Artefacts,” Business Information Systems 2015 Workshops, pp. 36-47 (2015); U.S. Pub No. 20160306790]. A descriptive level, with a reduced number of symbols but which is semantically enriched could be used to define high-level domain-specific process models. These models could then be refined in an analysis level [B. Silver, “BPMN Method and Style: A levels-based methodology for BPM process modeling and improvement using BPMN 2.0,” pp. 6-8, Cody-Cassidy Press (2009)], using for example BPMN.

Previously, domain-specific process design has been focused on a behavioral perspective [US Pub. Nos. 20150046212 and 20160162816; A. Mos, “Domain specific monitoring of business processes using concept probes,” Service-Oriented Computing-ICSOC Workshops, pp. 213-224, 2015; K. Suri, et al., “Human task monitoring and contextual analysis for domain specific business processes, 10th Int'l Conf. on Software & System Engineering (ICSSEA), pp. 27-29 (2015)]. These approaches define the activities (or steps) that are to be performed in a process. For example, in a contracting process, relevant activities to be captured and defined include “organization of a welcome meeting,” “creation of the new contract,” and “assignment of the working-post.” The behavioral description relies on the notion of a Domain concept (also referred to as an activity type), which corresponds to the organization know-how description. These domain concepts are linked to the defined process steps in order to capture the process design in an enriched and specific way.

These approaches, however, do not consider domain-specific business objects, but rely on generic objects, such as document objects.

### INCORPORATION BY REFERENCE

The following references, the disclosures of which are incorporated herein by reference in their entireties, are mentioned:

U.S. Pub No. 20130232464, published Sep. 5, 2013, entitled DEPLOYMENT OF BUSINESS PROCESSES IN SERVICE-ORIENTED ARCHITECTURE ENVIRONMENTS, by Thierry Jacquin; et al.

U.S. Pub No. 20150046212, published Feb. 12, 2015, entitled MONITORING OF BUSINESS PROCESSES AND SERVICES USING CONCEPT PROBES AND BUSINESS PROCESS PROBES, by Adrian C. Mos.

U.S. Pub No. 20160162816, published Jun. 9, 2016, entitled HUMAN TASK MONITORING AND CONTEXTUAL ANALYSIS FOR DOMAIN-SPECIFIC BUSINESS PROCESSES, by Kunal Suri, et al.

U.S. Pub No. 20160306790, published Oct. 20, 2016, entitled PRESERVING CONSISTENCY IN DOMAIN-SPECIFIC BUSINESS PROCESSES THROUGH SEMANTIC REPRESENTATION OF ARTIFACTS, by Adrian C. Mos, et al.

U.S. Pub No. 20160314351, published Oct. 27, 2016, entitled EXTENDING GENERIC BUSINESS PROCESS MANAGEMENT WITH COMPUTER VISION CAPABILITIES by Adrian C. Mos, et al.

U.S. application Ser. No. 15/228,493, filed Aug. 4, 2016, entitled GENERATING DOMAIN-SPECIFIC PROCESS STUDIOS, by Adrian C. Mos.

### BRIEF DESCRIPTION

In accordance with one aspect of the exemplary embodiment, a method for incorporating domain-specific business objects in process design. The method includes providing a domain meta-model, which links a set of elements, the elements including domain-specific business objects representing pieces of data, each of the domain-specific business objects being associated with a set of features, the set of features including an identifier feature. Business object definitions are incorporated into the domain meta-model to generate a domain model including the defined domain-specific business objects. A domain-specific process studio is generated, based on the domain model, which enables a user to edit a representation of a business process that includes a sequence of process steps. The representation of the business process includes at least one process step that is linked to one of the domain-specific business objects in the domain model. One or more of the steps of the method may be performed with a processor.

In accordance with another aspect of the exemplary embodiment, a system for process design includes memory which stores a domain model which links a set of elements, the elements including domain-specific business objects representing pieces of data, each of the domain-specific business objects having a set of features, the set of features including a unique identifier for the respective domain-specific business object, the domain model being linked to a process model which includes elements of a business process. Instructions are stored in memory for generating a domain-specific process studio based on the linked domain model and process model, including instructions for generating a graphical user interface on an associated display device which enables a user to edit a representation of a business process comprising a sequence of process steps. The business process representation includes at least one process step that is linked to one of the domain-specific business objects that are represented in the domain model. A processor implements the instructions.

In accordance with another aspect of the exemplary embodiment, a method for process design in a domain-specific process studio includes generating a model of a domain which links a set of elements, the elements including domain-specific business objects representing pieces of data and a set of domain-specific concepts. Each domain-specific concept is linked to one of the domain-specific business objects, each of the domain-specific business objects and domain-specific concepts having a set of features, the set of features including a unique identifier for the respective element. A process model, which includes elements of a business process, is linked to the domain-specific objects in the domain model through the domain-specific concepts. A graphical user interface enables a user to edit a representation of a business process comprising a sequence of process steps, wherein for the process steps in the representation that are linked to domain-specific business objects in the domain model, the representation identifies the linked domain-specific business objects. One or more of the steps of the method may be performed with a processor.

### BRIEF DESCRIPTION OF THE DRAWINGS

FIG. 1 is an overview of domain-specific process studio generation with particular reference to incorporation of domain-specific business objects, in accordance with one aspect of the exemplary embodiment;

FIG. 2, which is split into FIGS. 2A and 2B for ease of illustration, is a schematic view of an environment in which the domain-specific process studio operates, in accordance with another aspect of the exemplary embodiment;

FIG. 3, which is split into FIGS. 3A and 3B for ease of illustration, is a graphical representation of a domain meta-model which incorporates definitions for types of domain-specific business objects;

FIG. 4 is a schematic view of a graphical user interface for process design;

FIG. 5 is a flow chart illustrating a method for process design using a domain-specific process studio, in accordance with another aspect of the exemplary embodiment;

FIG. 6 is a schematic view of business object definition in the exemplary method of FIG. 5;

FIG. 7 illustrates an exemplary grammar and definition of a domain-specific business object;

FIG. 8 is a schematic view of a meta-model linking a process model and a domain model;

FIG. 9, which is split into FIGS. 9A and 9B for ease of illustration, is an example process representation based on the meta-model of FIG. 8;

FIG. 10 illustrates various views of a process which can be shown in the studio graphical user interface of FIG. 4; and

FIG. 11 illustrates a business object property view in the studio graphical user interface of FIG. 4.

### DETAILED DESCRIPTION

The exemplary system and method enable domain-specific business objects to be incorporated in process design for enriching the definition of an enterprise domain. The exemplary domain-specific business objects give an abstract and comprehensible view of the data flowing through processes in an enterprise.

A “domain-specific business object” (or simply, a “business object”) refers an abstract (generic) representation of a class of business objects. The exemplary system and method enable domain-specific business objects, e.g., of the class Document to be treated as a first-class citizen for the process design.

A “document,” as used herein refers to a piece of data, such as a text document, PDF document, or the like, and which can be referred to in a representation of a business process. The document may have been already created or may be created or updated in the process.

In the case of the contracting process, described above, for example, the present method enables types (subclasses) of the class document to be identified, e.g., a Contract or Employee Booklet, and for them to be explicit and well defined in the process model. In the process model, for example a specific hiring contract can thus be identified as being of the document type contract, which in turn, is a document, which in turn, is a business object.

The exemplary system can be configured similarly to those described in above-mentioned U.S. application Ser. No. 15/228,493, and U.S. Pub Nos. 20150046212 and 20130232464 (referred to as the '493, '212, and '464 applications). As described in the '493 application, the system provides a domain-specific process modeling language (DSPML)-based studio as a software application. The exemplary design studio includes elements for graphical design, monitoring, process querying, governance, connectivity to Service Oriented Architecture (SOA) elements, connectivity to a Business Process Management Suite (BPMS) and connectivity to other editors and tools.

In addition to providing for domain-specific studio generation and domain-specific process modeling and monitoring, the present system and method facilitate data management in the workflow through the modeling of domain-specific business objects. This adds differentiation to design studios built using the domain-specific approach. Users of the present system are able to define their domains from the perspective of documents, other pieces of data, and features that are domain-specific, i.e., which are applicable to their particular business. Users are then able to reuse these domain-specific business objects consistently and repetitively across business processes with the advantages provided by the domain-specific concepts (such as sweeping changes of document properties across processes, consistent connections between behavior and data for domain activities, extensible generation patterns when targeting specific deployment platforms such BPM engines complemented by content management and document sharing systems).

To extend the domain-specific processes described in the '493, '212, and '464 applications to include domain-specific business objects, business objects are considered as primary elements to complete the definition of the domain (structural view). Therefore, business objects are able to be integrated as part of the enterprise domain and can be linked to domain-specific concepts (activities occurring the domain, such as shipping or payment) and domain-specific services, which can be linked, in turn, to steps and services in a process specification.

The domain-specific business objects are fully integrated, allowing the governance facilities (i.e., understanding and control of the process) to be reused for the domain-specific business objects. This also means that the domain-specific business objects considered in a domain can be easily shared within a collection of processes. This also provides a data perspective that helps the business analyst to understand and define their domain processes (clarifying the frontiers between data and domain concepts). In one embodiment, the business objects Document, Part (of a document), and Attribute are employed. The present approach facilitates the alignment between the domain-specific layer and a domain-independent executable layer, using a modeling language, such as BPMN. While existing industrial BPM tools allow the definition of a Data-model, these tools tend to be data-base oriented (technical) and generic with respect to the business domain and therefore not well suited for business analysts.

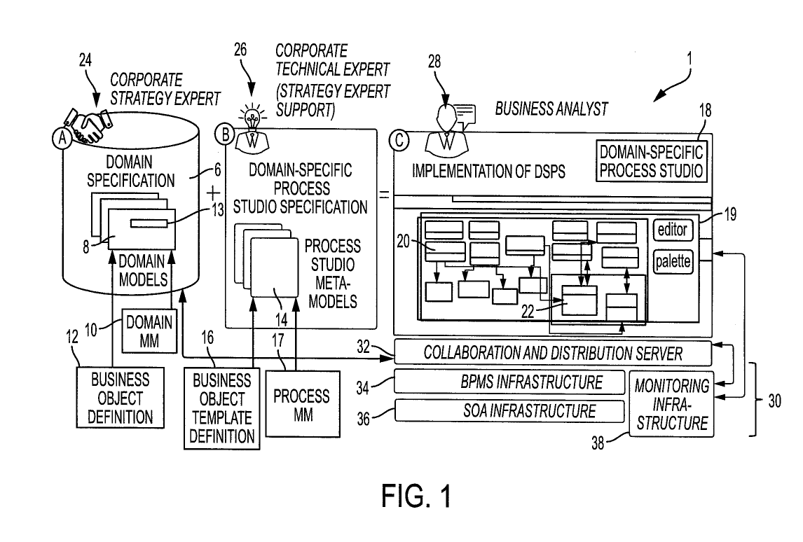

With reference to FIG. 1, an overview of aspects of a system 1 and method for business process design is shown, which illustrates the integration of domain-specific business objects in the workflow. The workflow includes three stages where domain-specific business objects are considered: A) domain specification, B) domain-specific studio specification, and C) design of a business process in a domain-specific process studio implementation. Stage A relies on the definition of domain-specific business objects, which correspond to the organization know-how description. The business objects that go through a process are therefore captured and modeled. In stage A, a common domain specification 6, which is applicable to one or more business domains, may be specialized to provide domain models 8, one for each set of business domains, e.g., healthcare, transportation, etc. The domain model 8 can be in the form of a textual description and/or a corresponding graphical representation. Each domain model 8 is based on a domain meta-model (domain MM) 10, which describes the structure of the business domain, and incorporates business object definitions 12 for creating domain-specific business objects 13. A domain model 8 is thus an instance of a domain MM 10, which describes the common domain specification for each business domain. The formal structure of a domain is thus described through the domain meta-model 10. The domain meta-model 10 formalizes the business concepts and the business objects (e.g., Document, Part, Attribute) that are used in that domain as well as formalizing the relations between the domain-specific concepts (e.g., Create and Update) and the business objects. The domain MM 10 can be extended or modified for specific organization needs.

Stage B (domain-specific process studio specification) may include the specification of one or more studio meta-models 14 incorporating business object template definitions 16 which enable domain-specific business objects to be generated in a domain-specific process studio (DSPS) 18 (in stage C), as well as providing templates and tools for other aspects of the DSPS, as described for example, in the '493 application. In stage C, in generating the studio meta-model 14 for a particular domain, links are created from a generic process meta-model 17, which describes links between elements of a process, to the domain meta-model 10.

A resulting Generated Domain-specific Process Studio (GDPS) 19 is an instance of the combined Domain Specific Process Studio Specification 17 and the Domain Specification 10. A GDPS may be generated for each business domain. In the exemplary domain-specific process studio specification 18, the structure of a generated domain-specific process studio (GDPS) is defined through several configurable templates in order to manage the studio functionalities, for example, the domain-specific process design, the deployment, and/or the monitoring functionalities. Tools are provided for defining mappings between the domain structural view 8 and the behavioral view of the process 17.

The business process being designed, which can be represented as a text description and also visualized graphically in the GDPS as a business process representation (or model) 20, includes representations 22 of a set of specific business objects (specific pieces of data), generated with the business object templates 16 incorporated in the domain model 8. This allows the specific pieces of data involved in the process to be referred to. For example a step with a condition if the bill is for more than $1000, obtain approval allows the representation 20 of the business process to include a business object representation 22 which represents the bill and/or a business object representation of a part of the bill referring to the amount.

The system allows different actors, such as a corporate strategy expert 24, a technical expert 26, and a business analyst 28, to interface with the system at the different levels. In stage A, the strategy expert 24 inputs the information that a domain model 8 should have, in general. The corporate technical expert 26, supported by the strategy expert 24, defines the overall studio functionality that all DSP studios 18 should have (such as BPMN transformation capabilities, monitoring capabilities, if these are desired). The definition of the business-object templates 16 may provide for generating data information from the defined business objects. The template may also define mappings between the domain structural view 8, generated from the domain MM 10, and the behavioral view, provided by the (domain independent) process meta-model 17. To achieve this, the process MM 17 refer to elements in the domain MM (via an ID reference) 10. For example, the mapping may imply a link between a step of the process and a business object. The process meta-model 17 includes process elements, such as steps and transitions, which are linked to services required by the steps. The process meta-model 17 specifies a number of basic elements describing process workflows and could be a small subset of BPMN 2.0.

The system 1 can be built on top of (or incorporate) an existing BPM infrastructure 30 which may include additional components, such as a collaboration and distribution server 32, a Business Process Management Suite (BPMS) infrastructure 34, a Service Oriented Architecture (SOA) Infrastructure 36, and a monitoring infrastructure 38. The system enables automatic generation of the modeling studios 19 where business analysts 28 can build their domain-specific processes (DSP). One or more common base templates may be provided in the GDPS for transforming the GDPS 19 to BPMN for deployment, for connectivity with the SOA 36, connectivity with the monitoring infrastructure 38 for monitoring of the BPMS infrastructure 34 and SOA 36, and for distributed collaboration via the server 32.

The generated domain-specific process studio (GDPS) 19 thus corresponds to a design, governance and collaboration layer on top of existing BPM technology infrastructure. The domain-specific process models 20 built in the GDSPs 19 can be transformed to a domain-independent business process modeling language, such as BPMN, in order to enable process execution. This transformation may be performed in the BPM architecture 30. Due to the preconfigured templates, the GDPS 19 is connected to the BPM stack 30 (as shown by arrows in FIG. 1). The generated BPMN models may be enhanced (i.e., enriched and refined) using platform-specific BPMN editors. The use of domain-specific business objects facilitates the process execution enhancement. Incorporating data-flow in the process through the use of domain-specific business objects, helps to characterize the control-flow of the process (e.g., the conditional gateways defining the process flow) or the execution activity pre-conditions (e.g., an activity not being able to start until there is an available document). Considering business-objects in an early stage of modeling completes the process definition.

The BPM structure described in the '493, '212, and '464 applications can be adapted for use with domain-specific business objects. For example, the collaboration and distribution server 32 ensures the data distribution across various remote instances 19 of the studio (on different computers), as well as the constant updating of the shared business objects. It will be appreciated that a large company may have at any given time, hundreds of users operating GDPS instances 19, for each industry class in which the company operates. As the domain knowledge evolves (e.g., a security policy), the system 1 may ensure that all the instances 19 share the latest version of the domain model 10. Also, with BPMN 2.0 as the target generation language, the alignment between BPMN's DataObjects and the exemplary domain-specific business objects is immediate.

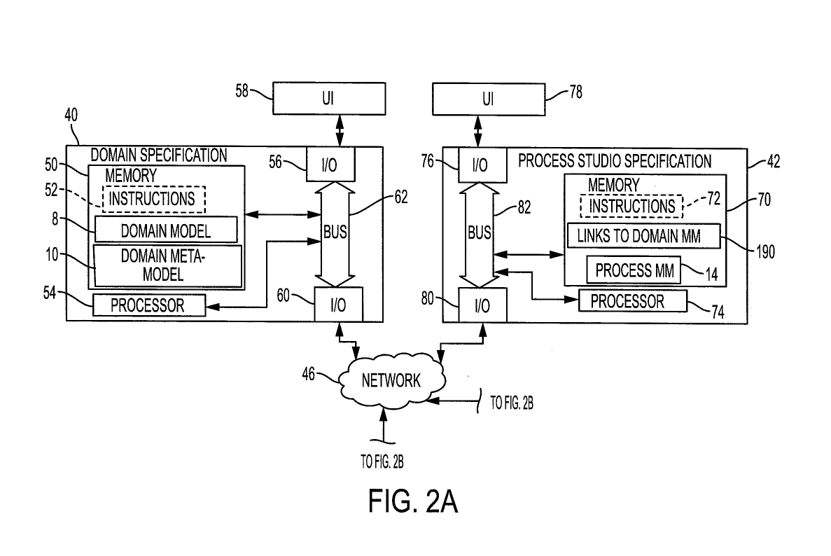

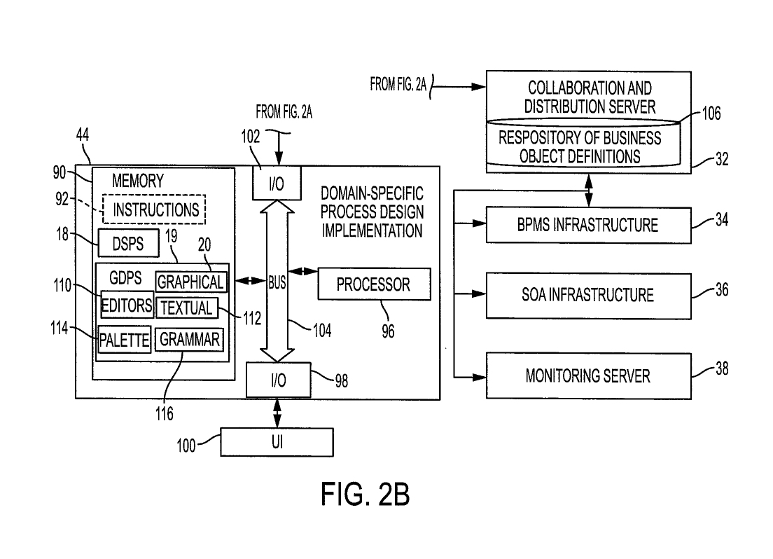

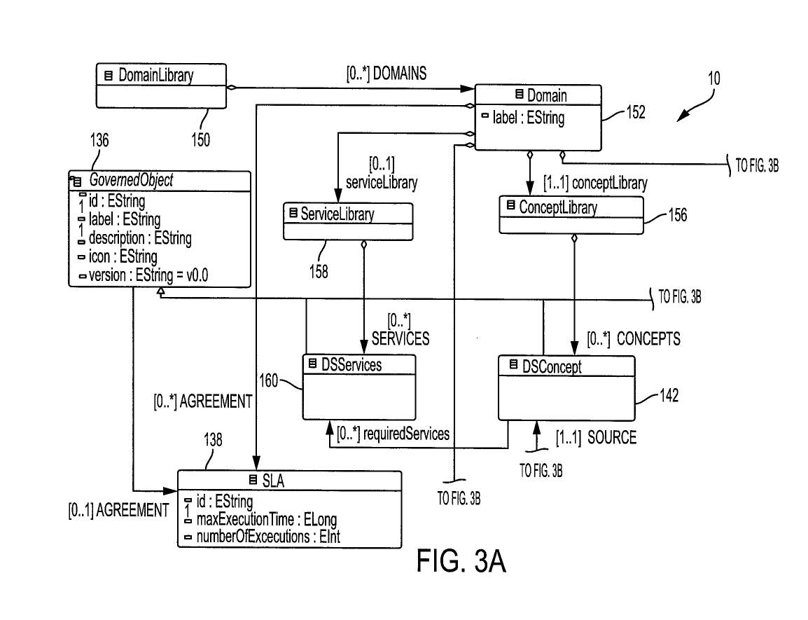

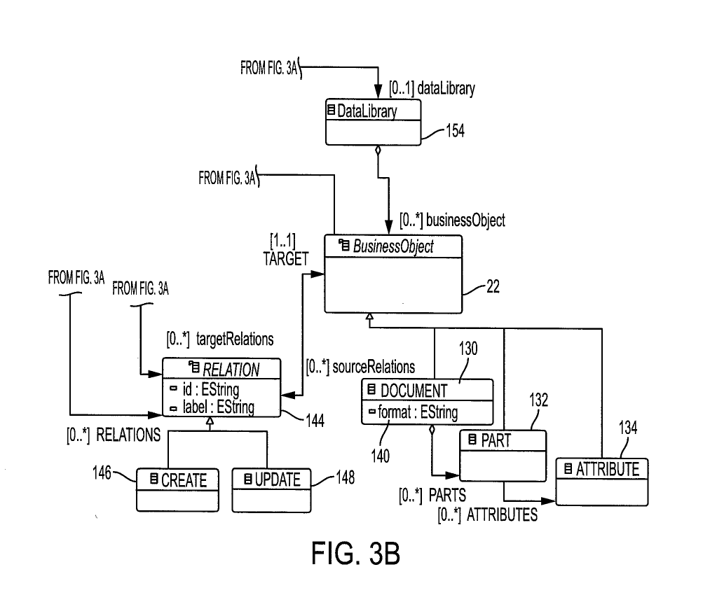

With reference also to FIG. 2 (split into FIGS. 2A and 2B), the system 1 may be distributed over remotely-located computers 40, 42, 44, etc., that are linked by a wired or wireless computer network 46. In particular, computer 40 includes memory 50, which stores instructions 52 for generating domain models 8 from domain meta-models 10, based on inputs by a user 24, and a processor 54 in communication with the memory for execution of the instructions 52. A first input/output interface 56 is communicatively connected with a user interface (UI) 58, such as a keyboard, keypad, touchscreen, display device, etc., through which the user 24 sends commands to the processor, such as business object definitions 12, and may view a representation of the generated domain model 8. A second input/output interface 60 communicatively connects the computer 40 to the network 46. Hardware components 50, 54, 56, 60 are connected by a data/control bus 62.

Similarly, computer 42 includes memory 70, which stores instructions 72 for managing DSP studio meta-models 14, based on inputs from a user 26, and a processor 74, in communication with the memory 70, for execution of the instructions 72. A first input/output interface 76 is communicatively connected with a user interface 78, through which the user 26 sends commands to the processor, such as business object template definitions 16 and definitions of domain concepts and process steps, and may view a representation of the domain meta-model 14. A second input/output interface 80 communicatively connects the computer 42 to the network 46. Hardware components 70, 74, 76, 80 are connected by a data/control bus 82.

Similarly, computer 46 includes memory 90, which stores instructions 92 for implementing the studio meta-model 14 in the DSPS 18, displaying the graphical representation 20 of the business process, and generating a GDPS 94. A processor 96, in communication with the memory 90, executes the instructions 92. A first input/output interface 98 is communicatively connected with a user interface 100, through which a user 28 sends commands to the processor, such as instructions for generating a model 20 of a business process which includes graphical representations 22 of the specific business objects involved in the process. A second input/output interface 102 communicatively connects the computer to the network 46. Hardware components 90, 96, 98, 102 are connected by a data/control bus 104. Business object definitions 12 may be stored in a centralized repository 106 to be shared in different cross-organization processes.

Various editing tools 110 are also provided, which allow users to construct or modify the displayed business process representation 20 and/or a textual representation 112 of the process. A set of reusable icons may be stored in a palette 114. The icons can be selected for representing the elements of the process, including the business objects. A grammar 116 controls the generation of the textual representation 112 of the process.

The computers 32, 34, 36, 38, 40, 42, 44 in the system 1, or associated therewith, may each include one or more of a PC, such as a desktop, a laptop, palmtop computer, portable digital assistant (PDA), server computer, cellular telephone, tablet computer, combination thereof, or other computing device capable of executing instructions for performing the exemplary method.

The memory 50, 60, 90 may each represent any type of non-transitory computer readable medium such as random access memory (RAM), read only memory (ROM), magnetic disk or tape, optical disk, flash memory, or holographic memory. In one embodiment, the memory 50, 60, 90 comprises a combination of random access memory and read only memory.

The network interface 60, 80, 102 allows the computer to communicate with other devices via a computer network 46, such as a local area network (LAN) or wide area network (WAN), or the internet, and may comprise a modulator/demodulator (MODEM) a router, a cable, and and/or Ethernet port.

The digital processors 54, 74, 96 can each be variously embodied, such as by a single-core processor, a dual-core processor (or more generally by a multiple-core processor), a digital processor and cooperating math coprocessor, a digital controller, or the like.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

### Integrating Domain-Specific Business Objects in the Domain-Specific Process

With reference also to FIG. 3 (split into FIGS. 3A and 3B), which shows the exemplary domain meta-model 10, the following terms are introduced in order to define business objects which may be used in the domain-specific process:

Domain-Specific Business Object (“business object”): this corresponds to an abstraction of all the data that is to be defined in a domain, and will be used in the enterprise processes. All the domain-specific business objects 128, 130, 132, 134 are considered to be governed objects 136. This means that they are each associated with a set of two or more predefined features, such as at least three features. Example features may include one or more of an identifier (id), a label, a version and a description. The subsequently instantiated specific business objects (represented by representations 22) are associated with values for the features, such as a unique id (UID), a specific label (e.g., contract), etc. As a governed object, this also means that the business object is linked to a Service Level Agreement (SLA) 138 (if one exists) to control the appropriate use of the related business object in the process. The id enables a specific business object 22 in the process 20 to be associated with a unique identifier, which distinguishes the particular domain-specific business object from other business objects and other elements of the process. The label is used to identify the business object in a graphical representation, such as Contract. The version represents the version of the document, which allows it to be linked to other versions(s) for example, if the document is to be modified. The description may list parts of the document. Each of these pieces of information may be in the form of a string of characters (EString). The features may also include an icon, which defines how the element is represented in the graphical representation. In this way, different elements may be represented by different colors, shapes, fonts, or other visually distinguishing characteristics.

Document: this is a class of business object 128 representing a document (e.g., a contract or an employee booklet). A document 130 has a format 140 (which defines the type of document) and may include zero, one, or several parts 132, each of which is less than the entire document 130.

Part: this is a business object 128 representing a part or section of a document (e.g., enterprise information or personal information). Parts 132 are included in a document 130. They cannot exist on their own (i.e., they are always included in a document). The id of a document (or part) can be used to retrieve an actual document, represented by the business object document 130, 132 from memory, e.g., memory of the collaboration and distribution server 32 or SOA infrastructure 36, when the business process is implemented.

Attribute: this is a business object 128 representing atomic information (e.g., an employee full name or enterprise contact information). Unlike part, an attribute 134 can exist on its own. Therefore, it could be shared by different documents or event not be attached to any document.

Relation: this represents the dependency connection between a domain-specific concept (DS Concept) 142 and a business object. For example, in process step “HireAction (DSConcept) creates Contract (Document),” the relation creates generates a dependency between a hiring action and a domain-specific business object, namely a contract. A relation 144 has an id and a label. As an example, there may be two (or more) types of relations 144, such as the illustrated relations Update 146 and Create 148. The domain MM 10 can be extended to include more and/or different relations.

The domain MM 10 provides a structural view of the domain and may include other objects as described in the '493, '212, and '464 applications. In the example domain MM shown in FIG. 3, the key elements of the particular business domain are defined. The domain MM represents the business domain information for an enterprise, with regard to the specification of concepts, business objects, and other elements that are going to be reused in the business processes. The domain MM 10 may include an overall Domain Library 150, which allows for any number of individual business domains 152, or it may be specific to a single business domain. For each domain 152, a respective data library 154, holds the domain-specific business objects, a concept library 156 holds a set of domain-specific business concepts 142, and a service library 158 holds a set of domain-specific services (DS Service) 160. A domain-specific concept 142 represents an activity of a process, which is linked by a relation to a business object. The domain-specific service elements 160 may refer to the service oriented architecture (SOA) services in the SOA infrastructure 34 required for the specific domain 152. The SOA services can be represented by abstract entities that are bound to the specific services in the SOA later in the deployment process. The service level agreements (SLA) 138 describe the various agreement details, including what the end user expects to be provided by the service provider. The DS Services 160, DS Concepts 142, business objects 128 and SLA agreements 138 are all considered as governed objects 136, and thus each is associated with a set of features, such as a respective id, label, description, version, and icon, although fewer or more features may be required in some cases.

The domain MM 10 thus enables business objects to be defined and to relate them to domain concepts (surrounding classes of governed objects) such as DS Concepts 142 and DS Services 160. Some elements from the domain MM 10, such as the DS Concept 142 and the DS Service elements 160, may also contain links to icon elements, which are useful for the graphical display of diagram elements and palette entries in the GDPS 19.

The domain MM 10 illustrated in FIG. 3 is a generic version of the domain specification 8 and can be instantiated with different configurations of the elements shown. As will be appreciated, in some instantiations of the domain MM 10, the data library 154 and/or service library 158 may be omitted/empty, for example, if no business objects and/or services are involved in the processes to be generated in the GDSP. Similarly, for some processes, there may be no governing SLA 138 and thus the element 138 may be empty.

One or more of the business objects 128, 130, 132, 134 is/are instantiated, in the domain model 8, as domain-specific business objects 13, by incorporating the business object definitions 12.

The domain MM 10 (instantiated as a domain model 8) can be used for several proposes, such as: 1) to store the domain information in a central repository 106, e.g., on the collaboration and distribution server 32; 2) to generate a domain editor (textual) 110 that can be used stand-alone or embedded in a graphical editor as part of a diagram designer; 3) to make the connection with the behavioral (process) view 14 that specifies how process steps are going to be represented; and/or 4) to inform and update Service-Level Agreements (SLAs) 138 for business concepts. Business object management ensures that all activities and all processes that refer to a particular document 130 can be easily handled. This can be advantageous, for example, when changes to company policies have implications for many documents 130, as they can be automatically propagated to all the relevant activities and processes.

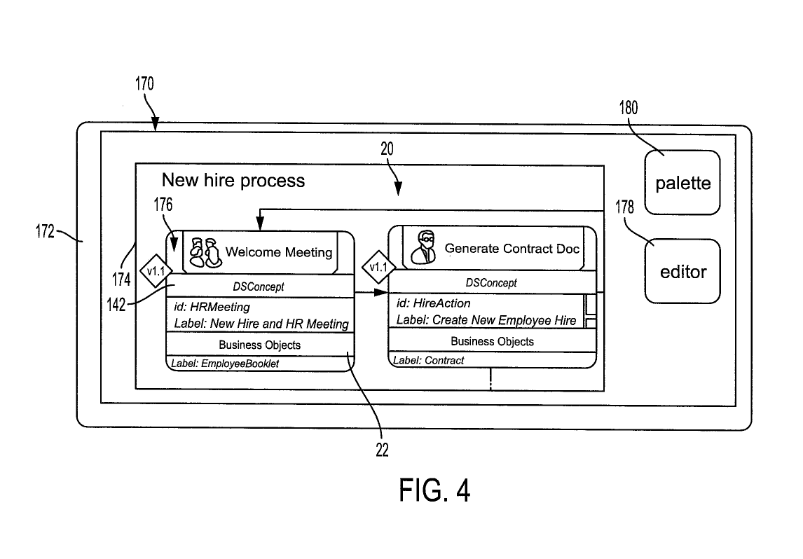

FIG. 4 illustrates a graphical user interface 170 which may be generated with the GDPS 19 on a display device 172 of a use interface, such as UI 100. The GUI 170 provides an editing window 174 in which a user can generate or modify a domain-specific process using icons 176 representing steps of the process, which may be selected from the palette 114 of icons, accessed through a palette button 178. An editor button 180 provides access to the various editing tools 110 stored in memory 90. The model 20 of the process thus generated includes links from the steps of the generated process to the particular instances of DS Concepts 142 and particular instances 22 of the domain-specific business objects involved in each step.

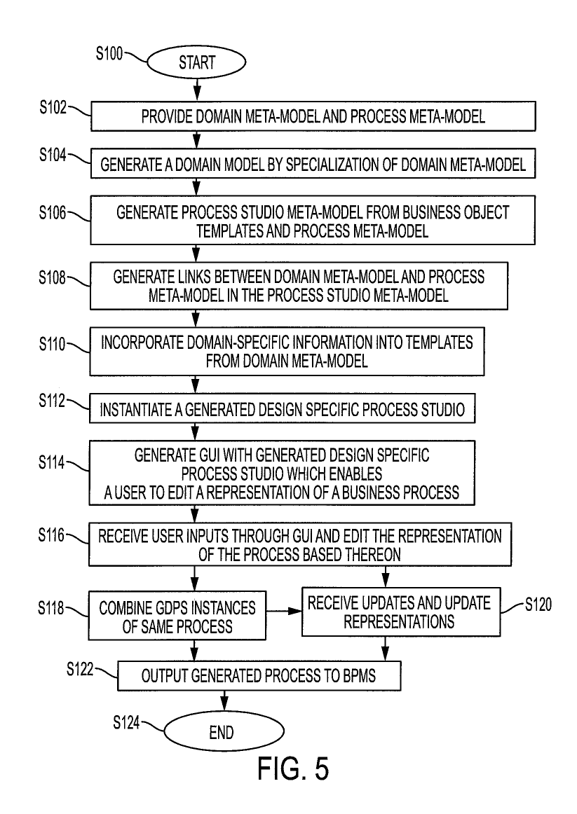

FIG. 5 is a flowchart illustrating an exemplary method of generating domain-specific graphical process studios which may be performed with the system 1 of FIG. 1. The method begins at S100.

At S102, a domain meta-model 10 and a process meta-model are provided (generated or already in existence). The domain MM 10 includes definitions, such as:
each business object has a set of features, such as an id, label, description, version, and icon,
each part is linked to the document that it is a part of,
each attribute is linked to a business object but does not need to be linked to a specific document,
each business object is linked to a domain-specific concept by a relation.

Definitions of relations 144 and other elements 160, 142, etc., of the domain meta-model are also included.

At S104, a domain model 8 is generated by specification of the domain MM 10, e.g., by incorporating business object definitions 12 for different types of business object, input by a user.

At S106, a domain-specific process studio meta-model 14 is generated by specification of the process meta-model 17, e.g. based on user inputs. The domain-specific process studio meta-model 14 includes business object template definitions 16, such as templates for documents, document parts, and attributes, which may be input by a user.

At S108, in the domain-specific studio meta-model 14, links are generated between the domain meta-model 10 and the process meta-model 17.

At S110, templates are generated from the template definitions 16, by filling in the blanks in the appropriate templates with the relevant domain information 8.

At S112, a GDPS 19 is instantiated or retrieved through the domain-specific process studio 18. This step uses the studio meta-model 14 that links the domain meta-model 10 to the process description 17. The GDPS may be instantiated from a template for generating the palette 114 and templates for generating the graphical and textual representations 22, 112 of a business process. If a GDPS 19 has already been created, it may be retrieved from memory. The instantiated domain meta-model 8 and GDPS templates (or just the ones that have changed since the last start) may be retrieved from the repository 106. It is to be understood that standard distributed-system approaches can be employed (i.e., caching of previously loaded data, smart difference computation in order to only bring in changed elements, etc.). If several domain-specific process studio meta-models 14 have been generated, a user may be permitted to select an appropriate one for his part of the business, or this may be automatically selected, based on his credentials.

At S114 a graphical user interface 160 is generated for the GDPS instance and is displayed, for example, via the computing device 44 on the display device 162 of the user interface 100. The GUI enables a user to edit, e.g., to create or update, a graphical and/or textual representation 20, 112 of a domain-specific process in which links to specific business objects are created.

At S116, the GDPS receives inputs from a user for generating process steps and representing them in the GUI. Users may create processes, can load previously created processes and so forth, in the form of graphical representations (process diagrams) and/or their corresponding textual descriptions. Such diagrams may be seen as “views” over processes, because some diagrams may be richer than others in details (for the same process).

At S118, data regarding collaboratively edited diagrams may be received from a number of users. Since other users may use GDPS instances all connected to the centralized repository 106, two or more users can collaborate on the same process diagram. The collaboration and distribution server 32 provides, among other things, live collaboration support, including object locking and so on.

At S120, updates from the monitoring server 38 may be used for populating the process representation 20, e.g., by providing new version numbers for represented documents that have been modified.

At S122 a generated process is converted to BPMN and output to the BPMS infrastructure 34 where it can be manipulated and/or deployed in the SOA 36. Specific artefacts (data objects) are generated in BPMN for the business objects involved in the process.

The method ends at S124.

The method illustrated in FIG. 5 may be implemented in a computer program product or products that may be executed on a computer or computers. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 5, can be used to implement the method. As will be appreciated, while the steps of the method may all be computer implemented, in some embodiments one or more of the steps may be at least partially performed manually.

Further aspects of the system and method will now be described.

Integrating Domain-Specific Business Objects into the Domain Meta-Model

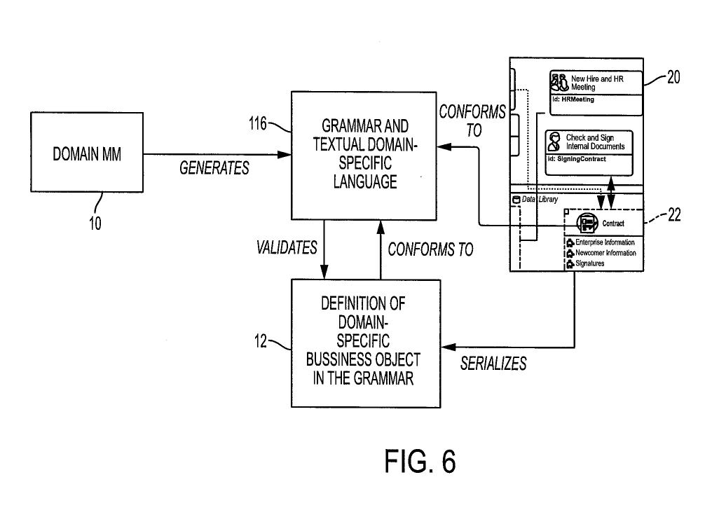

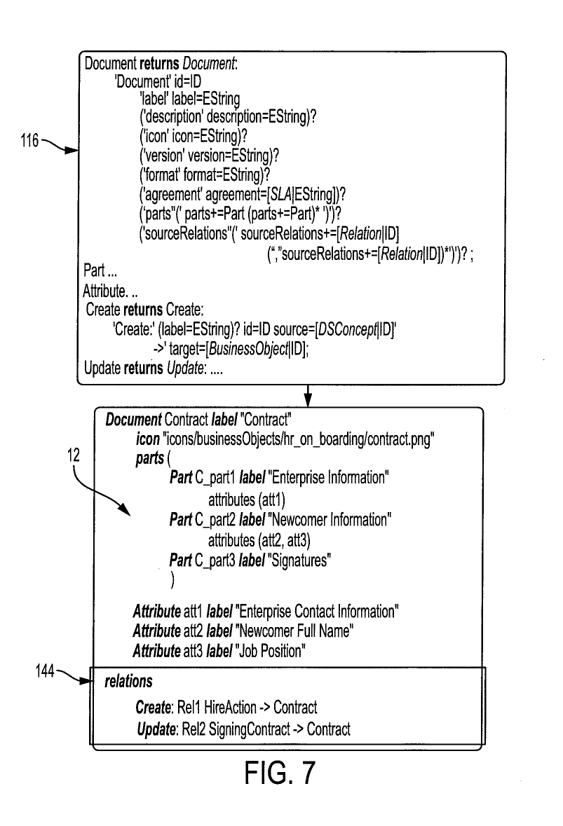

With reference to FIG. 6, aspects of the method related to specifying of domain-specific business objects 12 (S104) are illustrated. The domain MM 10 is the starting point, from which a formal grammar 116 is automatically generated. The grammar 116 can be enriched or updated over time. The actual business-object definition 12 in the domain relies on the grammar. FIG. 7 shows an example of a contract definition 12 that conforms to the grammar 116. The “Contract” may include some document parts (e.g., Enterprise Information) and attributes (e.g., Newcomer Full Name). A business analyst 28 can use the grammar to define a domain, using different editors 114 provided by the domain-specific process studio 18. For example, the definition of a relation 144 between a domain concept 142 and a document 130 (or other business object 128) can be formalized with the grammar. A business analyst 28 may also define the domain in the graphical representation 20, which includes graphical representations 22 of the domain-specific business objects 12. In the exemplary embodiment, the textual specification and the graphical representation 20 of the domain are synchronized. Knowledge common to the enterprise is thus stored in domain-specific elements 128, 130, 132, 134, rather than being implicit in the minds of the designers or managed with textual annotation.

### Connecting Business Objects to the Domain-Specific Process

The domain-specific process studio specification (S106) concerns the main features of the design studio 18 where the business analyst builds models. This specification relies on a number of stored templates provided by the framework that facilitate the process design. At this stage, the connection between the business objects and the process definition 17 is made (S108).

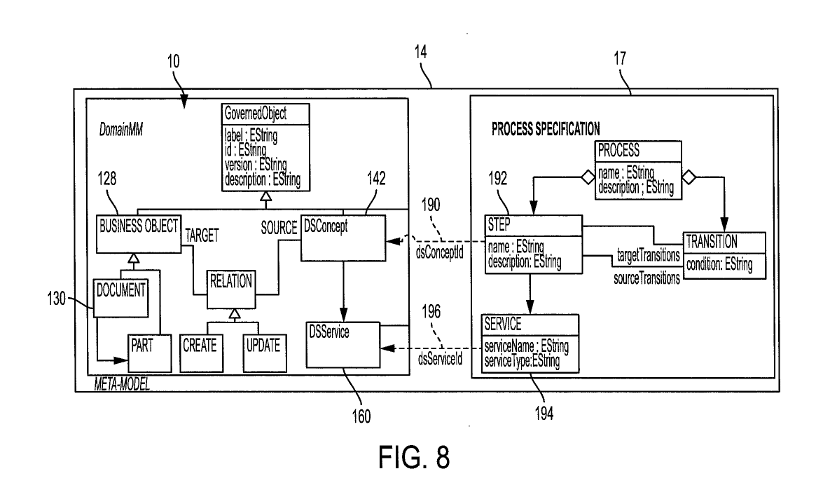

This linking is illustrated in FIG. 8. Links 190 to steps 192 in the process model 17 are created with the DSConcept element 142. The mapping between the process steps 192 and specific ones of the business objects 128 and concepts 142 relies on the unique ID (UID) features 136 of the linked elements. Representations 194 of services employed in the process specification are linked by links 196 to a corresponding DS Service 160 in the domain MM 10. As is evident from FIG. 8, not all process steps built with the process model 17 need to be linked to a business object through the DS Concept, since not all processes relate to business data.

As described in U.S. Pub. No. 20150046212 and Mos, “Domain specific monitoring of business processes using concept probes,” Service-Oriented Computing-ICSOC Workshops, Springer, pp. 213-224, 2015, the process meta-model 17 may be a common meta-model (CommonMM), which is a central, simplified representation of the main generic process concepts common to business process descriptions, such as activity, flow and gateway and may be defined in BPMN or other generic process language, which facilitates transfer to the BPMS 34. Its objective is simply to extract the essence of the structure of various business processes.

### Domain-Specific Process Studio

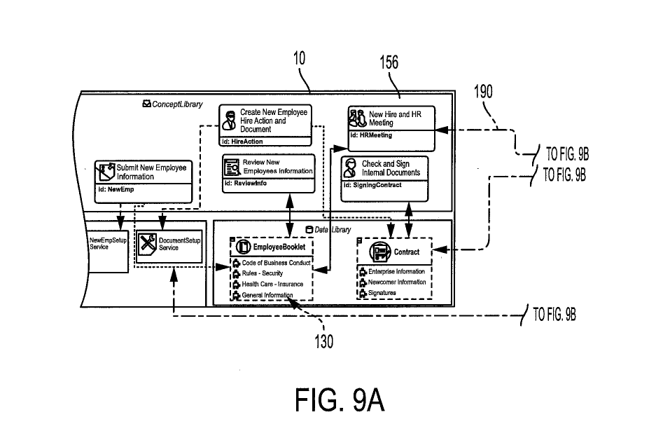

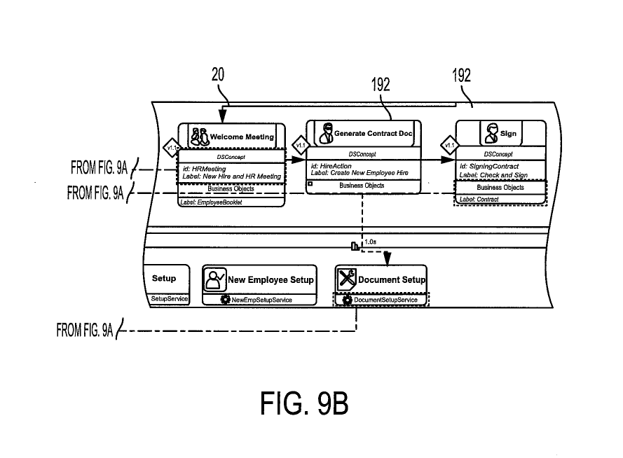

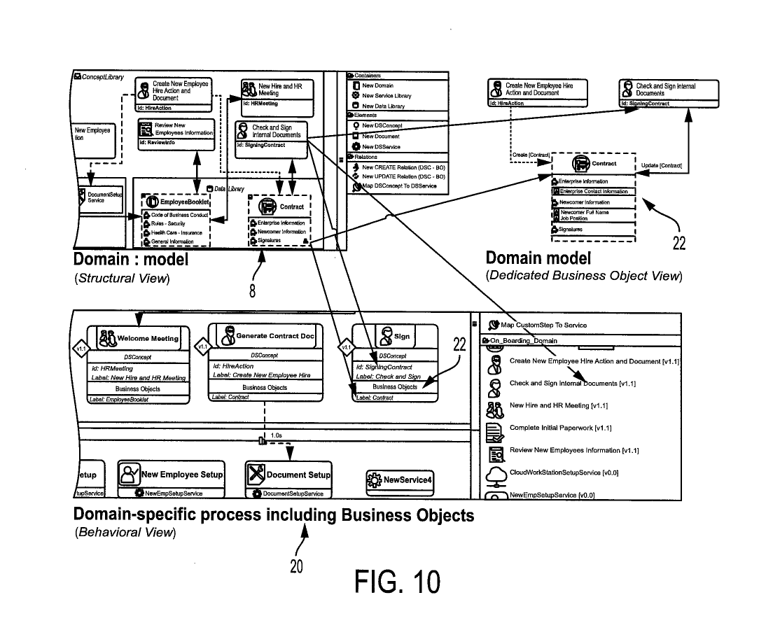

FIGS. 9-11 show screen-shots of portions of the business object graphical representation in a business process representation 20. These representations are examples that can easily be modified using the graphical specification templates. The graphical principles proposed by Moody [D. L. Moody, “The ‘physics’ of notations: toward a scientific basis for constructing visual notations in software engineering,” IEEE Trans. on Software Engineering, 35(6) 756-779, 2009] may be used to build the graphical representation. For example, the principle of Semiotic Clarity is respected. This establishes a one-to-one correspondence between graphical symbols and the semantic elements in the meta-model. The principle of Semantic Transparency is also respected by using icons that suggest the related semantic element (e.g., Document). Different views can be generated, as shown in FIG. 10, respecting the Complexity Management principle. At the same time, the Cognitive Integration principle is considered by using the same information and representation in the different diagrams. The principle of Visual Expressiveness is also taken into account by using different shapes, textures and colors in order to highlight the distinction between elements.

In creating a representation 20 of a process, the user may create, for example, a payment step 192. All steps generated in all the process descriptions for the given domain that are of the type payment are linked, via the DSConcept 142 with the label payment in the model 8 to the business object 22 having the label bill in the model 8.

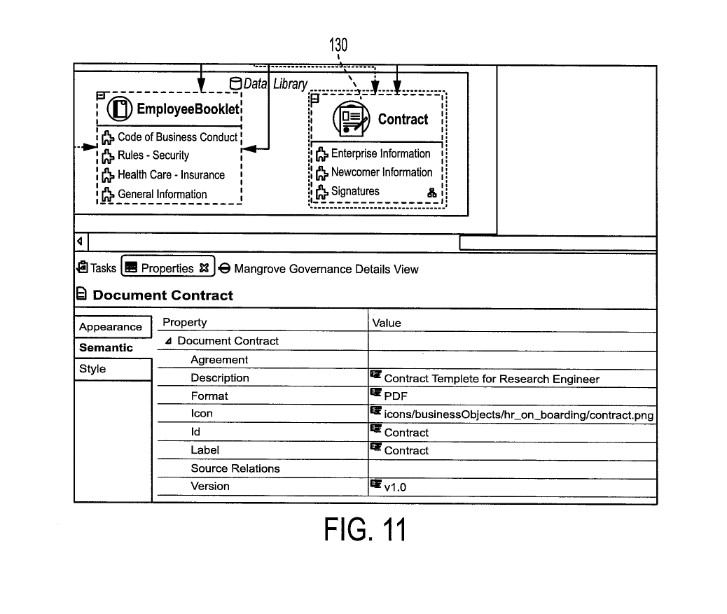

FIG. 11 shows that not all the information defined in the domain MM 10 needs to be represented graphically. When the analyst clicks on a graphical element, a properties view provides the (editable) information of the selected element. All the attributes considered in the domain MM can be shown in this view.

### Example Implementation

The prototype implementation is integrated in the current framework. This prototype relies on a set of open-source Eclipse technologies. These are useful for any BPM suite, many of which are actually built using Eclipse. The screen-shots shown in FIG. 9 (split into FIGS. 9A and 9B) and FIG. 10 give an overview of the prototyping work.

The Eclipse Modelling Framework (http://www.eclipse.org/modeling/emf/) for the definition of the meta-models. The Eclipse Xtext (https://eclipse.org/Xtext/) is used to generate tool support with a textual editor for domain models relying on the domain MM. Ecore meta-models are the inputs for the Sirius domain-specific editor (https://eclipse.org/sirius/). This tool allows an easy creation of the configurable graphical modeling studios (definition of the templates and the interpreted user interface). The Mangrove Meta-model (https://www.eclipse.org/mangrove/) is used as the process meta-model 17 that is linked to the domain meta-model 10 and also to the BPMN 2.0 meta-model for generation purposes.

The basic Mangrove meta-model does not consider the data objects as primary elements like BPMN 2.0 does. To provide flexibility and data-customization, the Mangrove meta-model is extended to consider Data Objects related to Steps (i.e., capture the definition of inputs and outputs of the steps). This permits the definition of custom data objects and particular data properties at the process level, not necessarily linked to the domain specification.

Existing data-model definition approaches are typically technology-specific and generic with respect to the business domain. This limits the ability of business matter experts to express their intent and enact process change. The exemplary system and method described herein provides the business stakeholders with means to govern and maintain their business-objects from a high-level, with impact to the entire collection of business processes in a domain, if required. Relying on domain-specific business-objects, analysts are able to model and control the documents of a large collection of process descriptions. Capturing domain-specific business objects in this way provides several advantages, including:

1. a centralized management of the enterprise documents and data that can be reused for different processes,

2. a better understanding of the process by business analysts since it shows their day-to-day operational details, and

3. more precise description of the domain, and therefore the processes, facilitating the subsequent definition of execution capabilities. This is useful when generating BPMN or other target artefacts such as specific elements required by an enterprise content management and document sharing system.

The solution is supported by tools that automate the definition of the business objects in a graphical environment. The domain-specific layer provides powerful means to understand and model a key part of processes in order to enable work-flow automation and overall process governance. It can also benefit from monitoring probe integration in order to enhance business process analysis.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for incorporating domain-specific business objects in process design, the method comprising:
providing a domain meta-model, which links a set of elements, the elements including domain-specific business objects representing pieces of data, each of the domain-specific business objects being associated with a set of features, the set of features including an identifier feature;
incorporating definitions for domain-specific business objects into the domain meta-model to generate a domain model including the defined domain-specific business objects;
with a processor, generating a domain-specific process studio based on the domain model, which enables a user to edit a representation of a business process comprising a sequence of process steps, the representation of the business process including at least one process step that is linked to one of the domain-specific business objects in the domain model.

2. The method of claim 1, comprising generating a domain model for each of a plurality of domains, each of the domain models including a respective set of domain-specific business objects.

3. The method of claim 1, wherein the domain-specific business objects are represented in the domain meta-model as documents, document parts, and attributes.

4. The method of claim 1, wherein the elements of the domain meta-model include a set of domain-specific concepts, each domain-specific concept being linked by a relation to a domain-specific business object.

5. The method of claim 4, wherein each of the domain-specific concepts includes a set of features, the set of features including a unique identifier for the respective domain-specific concept.

6. The method of claim 4, wherein the at least one process step is linked to one of the domain-specific business objects through a respective one of the domain-specific concepts.

7. The method of claim 1, wherein the features of the domain-specific business objects further include at least one of a label, a version and a description.

8. The method of claim 1, wherein the elements of the domain meta-model further include a set of domain-specific services, each of the domain-specific services being linked to one of the set of domain-specific concepts, each of the domain-specific services having a set of features, the set of features including a unique identifier for the respective domain-specific business service.

9. The method of claim 1, further comprising receiving inputs from a user and editing a business process based on the inputs.

10. The method of claim 9, further comprising displaying the edited business process in a graphical user interface which visualizes the links between the process steps and the respective domain-specific business objects.

11. The method of claim 9, further comprising generating a representation of the business process in a generic Business Process Model and Notation language in which the features of the business objects are retained.

12. The method of claim 1, wherein the domain meta-model is configured to at least one of: describe a data structure of arbitrary domain models, store domain information for the domain-specific business objects for a business domain in a central repository, generate a domain editor for editing the domain model of the business process, and specify and update Service Level Agreements represented in the domain model.

13. The method of claim 1, wherein the generating a domain-specific process studio comprises instantiating a set of templates based on information stored in the domain model.

14. The method of claim 1, further comprising generating links between the process model and one or more of the domain-specific business objects.

15. A computer program product comprising a non-transitory recording medium storing instructions, which when executed on a computer, cause the computer to perform the method of claim 1.

16. A system comprising memory storing instructions for performing the method of claim 1 and at least one processor in communication with the memory for executing the instructions.

17. A system for process design comprising:
memory which stores a domain model which links a set of elements, the elements including domain-specific business objects representing pieces of data, each of the domain-specific business objects having a set of features, the set of features including a unique identifier for the respective domain-specific business object, the domain model being linked to a process model which includes elements of a business process;
instructions stored in memory for generating a domain-specific process studio based on the linked domain model and process model, including instructions for generating a graphical user interface on an associated display device which enables a user to edit a representation of a business process comprising a sequence of process steps, the business process representation including at least one process step that is linked to one of the domain-specific business objects that are represented in the domain model; and
a processor which implements the instructions.

18. The system of claim 17, further comprising a collaboration and distribution server which stores domain-specific business objects in a repository accessible to a plurality of users which are interacting with graphical user interfaces on respective display devices.

19. The system of claim 17, further comprising an infrastructure for deploying the business process in a service oriented architecture which implements the business process, the service oriented architecture having access to business data represented by the domain-specific business objects.

20. A method for process design in a domain-specific process studio, the method comprising:
generating a model of a domain which links a set of elements, the elements including domain-specific business objects representing pieces of data and a set of domain-specific concepts, each domain-specific concept being linked to one of the domain-specific business objects, each of the domain-specific business objects and domain-specific concepts having a set of features, the set of features including a unique identifier for the respective element;
linking a process model, which includes elements of a business process, to the domain-specific objects in the domain model through the domain-specific concepts;
generating a graphical user interface which enables a user to edit a representation of a business process comprising a sequence of process steps, wherein for the process steps in the representation that are linked to business objects in the domain model, the representation identifies the linked business objects.
